(19) United States
(12) Patent Application Publication
(10) Pub. No.: US 2018/0061276 A1
(43) Pub. Date: Mar. 1, 2018

(54) METHODS, APPARATUSES, AND SYSTEMS TO RECOGNIZE AND AUDIBILIZE OBJECTS

(71) Applicant: Intel Corporation, Santa Clara, CA (US)

(72) Inventors: Jim S. Baca, Corrales, NM (US); Amrish Khanna Chandrasekaran, Chandler, AZ (US); Neal P. Smith, Folsom, CA (US); Baranidharan Sridhar, Chandler, AZ (US)

(21) Appl. No.: 15/253,477

(22) Filed: Aug. 31, 2016

(51) Int. Cl. G09B 21/00; H04N 7/18; H04N 13/02; G10L 15/22; G06K 9/00; G10L 13/04

(52) U.S. Cl. CPC G09B 21/007; H04N 7/185; H04N 13/0207; G10L 2015/223; G06K 9/00375; G06K 9/00671; G10L 13/043; G10L 15/22

(57) ABSTRACT

Apparatuses, methods, and systems to assist a visually-impaired user. Embodiments include a 3D depth camera to be worn or co-located with the visually-impaired user to collect data to recognize an object in an environment and to collect data to locate the object relative to the visually-impaired user in the environment; and a speech-based interaction device to communicate to the visually-impaired user recognition and location of the object based on the data collected by the 3D depth camera. Embodiments may include use of a haptic feedback device to provide tactile feedback to the visually-impaired user to positively or negatively reinforce a location of the visually-impaired user relative to the object to allow the user to grasp the object. Other embodiments may also be described and claimed.

### FIELD

Embodiments of the present invention relate generally to the technical field of computer vision, and more particularly to 3D depth image capture and processing.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Current technology does not offer object detection and recognition systems that are sufficient to assist visually-impaired users to navigate and interact with their environments. New solutions to help guide the visually-impaired during their activities in the home, workplace, and outside environments are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIGS. 1 and 2 illustrate an example visual assistance device, in accordance with various embodiments.

FIG. 3 illustrates an example method associated with the visual assistance device of FIGS. 1 and 2 in accordance with various embodiments.

FIG. 4 is a block diagram of an example visual assistance device configured to employ the apparatuses and methods described herein, in accordance with various

FIG. 5 illustrates an example flow diagram of a process employed by a visual assistance device in accordance with various embodiments.

FIG. 6 is an example computer system suitable for use to practice various aspects of the present disclosure, in accordance with various embodiments.

FIG. 7 illustrates a storage medium having instructions for practicing methods described with references to FIGS. 1-6 in accordance with various embodiments.

### DETAILED DESCRIPTION

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs having machine instructions (generated from an assembler or compiled from a high level language compiler), a combinational logic circuit, and/or other suitable components that provide the described functionality.

Embodiments described herein include methods, apparatuses, and systems to recognize and audibilize objects to assist a visually-impaired user. In embodiments, a visual assistance device may acquire an input feed of data from a 3D depth camera co-located with a user, e.g., worn by the user, to identify a plurality of objects and their locations relative to the user as the user moves within an environment. The visual assistance device may acquire an additional input feed of data from the 3D depth camera to update identification of the plurality of objects and their locations relative to the user as the user moves within the environment according to embodiments and based upon the updated identification of the plurality of objects and their locations, may provide directions to audibly communicate to the user a location of a recognized object of the plurality as the user moves toward the recognized object in the environment.

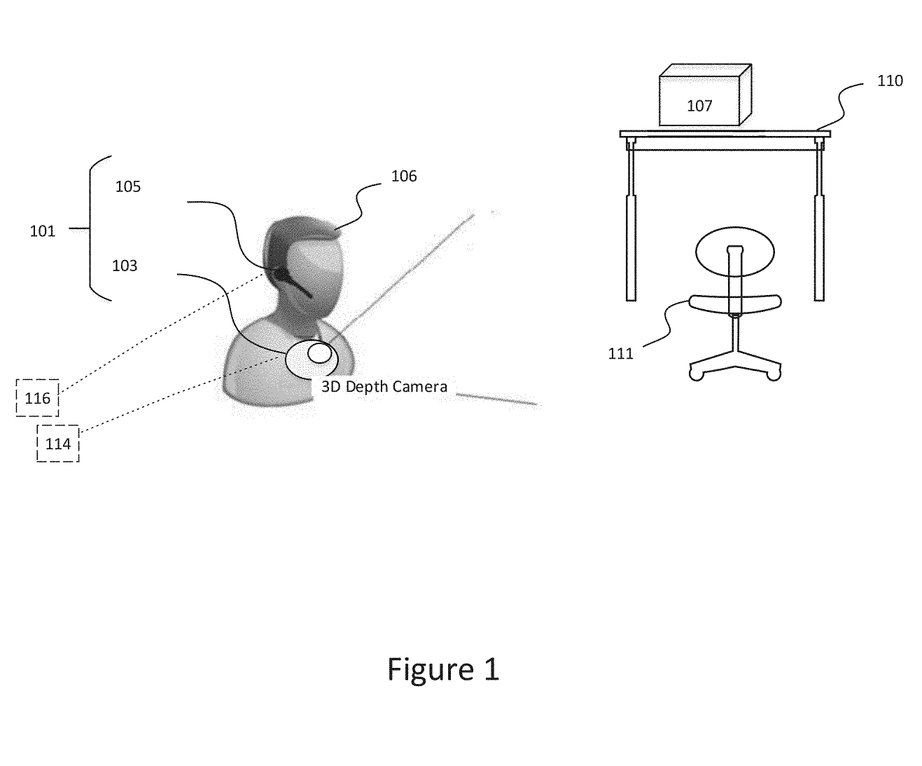

FIG. 1 illustrates an example visual assistance device 101 (“device 101”) that may assist a visually-impaired user (“user 106”), in accordance with various embodiments. In embodiments, device 101 may include a 3D depth camera 103 and a speech-based interaction device 105. In embodiments, 3D depth camera 103 and speech-based interaction device 105 may be worn by or co-located with user 106 (e.g., held by user 106). In embodiments, 3D depth camera 103 may collect data in an environment such as for example, home, workplace, outside, or other environment where user 106 may need assistance. In an embodiment, speech-based interaction device 105 may include speakers to provide voice-guided directions to user 106 to locate and/or avoid a plurality of objects in the environment, such as, for example, an object 107, a table 110, and a chair 111. In some embodiments, such as when user 106 may be in an outside environment, device 101 may help user 106 locate and/or avoid curbs, streets, sidewalks, trees, and other landmarks or obstacles, etc. (not shown). Note that in embodiments, object 107 may represent any household, workplace, perishable, or other object that user 106 may desire to locate.

Accordingly, in some embodiments, 3D depth camera 103 may learn an environment frequented by user 106. For example, in embodiments, 3D depth camera 103 may acquire an input feed of the environment to allow identification and location of e.g., table 110 and chair 111. In embodiments, 3D depth camera 103 may subsequently acquire an additional input feed of the environment to allow update of locations of table 110 and chair 111 and/or identify new or missing objects. Based upon the updated location of table 110 and chair 111, speech-based interaction device 105 may provide voice-based assistance to user 106 indicating recognition and updated location of table 110 and chair 111 as user 106 moves toward table 110 and chair 111 in the embodiment. Note that in some embodiments, speech-based interaction device 105 may receive a voice command from user 106 to locate a specific object, e.g. object 107. Based on the input feed of the environment and/or a prior input feed of the environment, speech-based interaction device 105 may include speakers to provide an audible response to the voice command including voice-guided directions to the information to user 106.

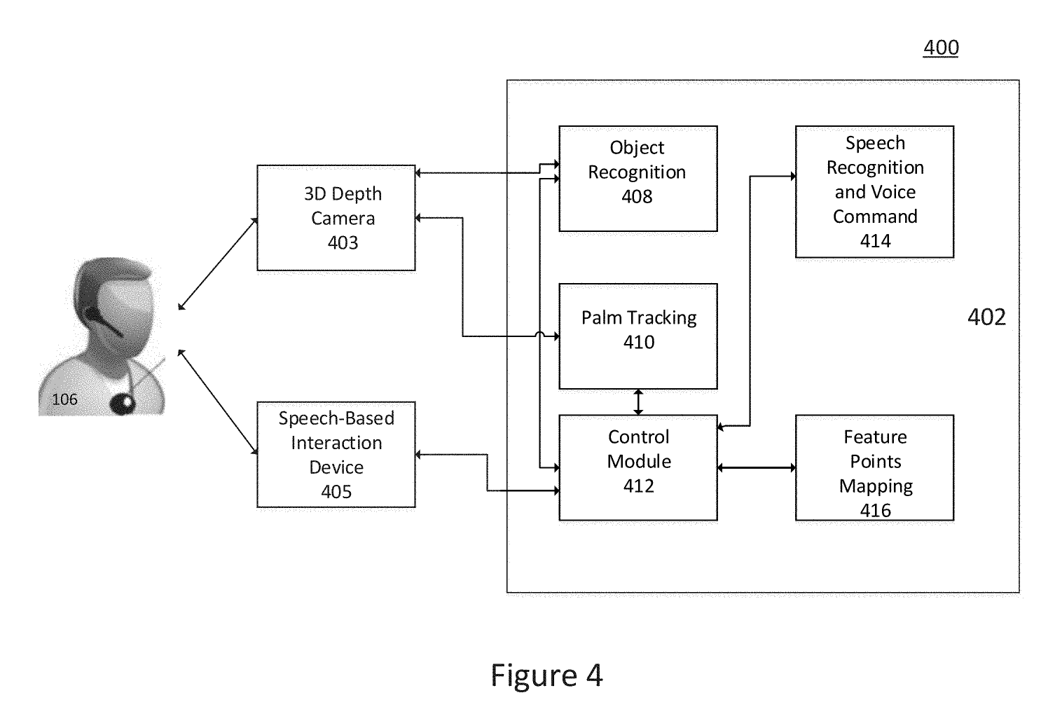

In embodiments, 3D depth camera 103 may include a wireless transceiver 114 that includes a radiofrequency (RF) transmitter and receiver to transmit collected data to a remote device. In embodiments, speech-based interaction device 105 may also include a wireless transceiver 116 to receive a voice command from user 106 and to transmit the voice command to the remote device. For the embodiment, transceiver 116 may also receive information regarding voice-guided directions for the user from the remote device to user 106. In embodiments, the remote device may be a remote computer device such as further discussed in connection with FIGS. 4-6. Note that in embodiments, 3D depth camera 103 may be any suitable 3D depth camera that may provide depth measurements between user 106 and object 107. In embodiments, depth camera 103 may be a camera such as or similar to Intel RealSense Camera™.

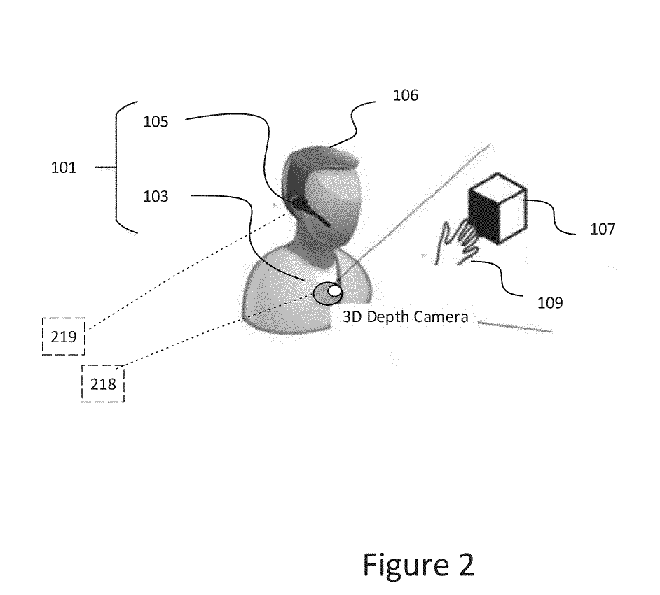

As illustrated in the embodiments of FIG. 2, 3D depth camera 103 may collect data to assist user 106 not only to locate objects and obstacles, but to grasp them as well. In embodiments, one or more of 3D depth camera 103 and speech-based interaction device 105 may include a respective haptic feedback device 218 and 219 to provide tactile feedback to user 106 to positively or negatively reinforce a location of user 106 relative to object 107. In embodiments, tactile feedback may be based on palm tracking which may help determine a location of a palm 109 of hand of user 106 relative to object 107. Haptic feedback device 218 and/or 219 may provide a vibration, force, or motion to indicate in which direction user 106 should move his or her body and/or hand in order to grasp object 107 according to various embodiments.

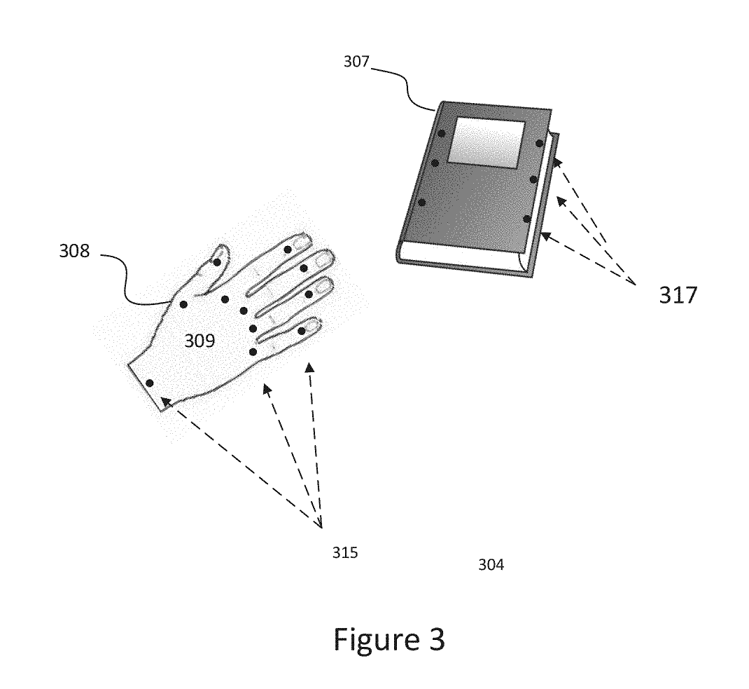

FIG. 3 illustrates an example method associated with palm tracking to direct user 106 to grasp an object such as for example, a book 307, in accordance with various embodiments. In embodiments, 3D depth camera 103 may scan a hand 308 including a palm 309 of user 106 to detect and track joints of hand 308 as joint coordinates 315. In embodiments, 3D depth camera 103 may also scan book 307 to determine one or more feature points 317 of book 307 (for clarity in the figure, only a portion of joint coordinates and feature points have been labeled). Accordingly, joint coordinates 315 may be mapped to feature points 317 to determine audible or haptic directions to be provided to assist user 106 in locating and grasping book 307. In embodiments, feature points 317 may be selected to be locations or points on a recognized object which may be grasped by user 106 or may be locations from which audible or haptic directions to assist user 106 can be effectively determined.

FIG. 4 is a block diagram 400 of an example visual assistance device configured to employ the apparatuses and methods described herein, in accordance with various embodiments. In embodiments, block diagram 400 may include a Recognition and Audibilization block 402 including a plurality of modules Object Recognition 408, Palm Tracking 410, Control Module 412, Speech Recognition and Voice Command 414 and Feature Points Mapping 416 which may operate on one or more computer processors communicatively coupled to 3D Depth Camera 403 and/or Speech-Based Interaction Device 405. In embodiments, Control Module 412 may be responsible for communication between modules 408-416 and may coordinate function calls between one or more of modules 408-416. In various embodiments, one or more of modules 408-416 may be co-located with 3D Depth Camera 403 and/or Speech-Based Interaction Device 405 or one or more of modules 408-416 may be included in a remote computer device communicatively coupled to 3D Depth Camera 403 and/or Speech-Based Interaction Device 405.

In embodiments, Object Recognition 408 may be configured to recognize an object, in particular, Object Recognition 408 may be coupled to receive data collected by 3D Depth Camera 403, such as an input feed, to process the data to recognize an object. In embodiments, performing object recognition or processing the data may include extraction of details from images of objects and comparison of the details to information in a database for identification or recognition of the object. In embodiments, Object Recognition 408 may scan the object to acquire coordinate markers or feature points corresponding to the object from the received data, and send the feature points to Control Module 412. In embodiments, Palm Tracking 410 may be configured to track the palm of a user, in particular, Palm Tracking 410 may be coupled to 3D Depth Camera 403 to receive images of a palm of a user. Palm Tracking 410 may process the image to determine joint coordinates, and send the joint coordinates to Control Module 412 according to various embodiments. According to embodiments, Feature Points Mapping 416 may be configured to generate mapping information, in particular, Feature Points Mapping 416 may acquire the feature points as well as joint coordinates from Control Module 412 and may use feature points mapping logic to generate mapping information. In embodiments, Feature Points Mapping 416 may map the feature points of the recognized object to a location of the user or to the joint coordinates of the user, according to various embodiments.

In embodiments, Speech-Based Interaction Device 405 may be configured to recognize a user's voice command. Speech-Based Interaction Device 405 may include a microphone to receive a user's voice command. For the embodiment, Speech Recognition and Voice Command 414 may be coupled to receive the user's voice command from Speech-Based Interaction Device 405 via Control Module 412 and convert the command to an appropriate function call to be executed by Object Recognition 408 or Palm Tracking 410. Furthermore, in embodiments, Speech Recognition and Voice Command 414 may generate and provide to Speech-Based Interaction Device 405, signals for audible or voice-guided directions based on the mapping information_from Feature Points Mapping 416. In embodiments, Speech-Based Interaction Device 405 may also include a haptic feedback device (as shown in FIG. 2) to provide tactile feedback to positively and/or negatively reinforce the user's hand movements. Accordingly, Speech-Based Interaction Device 405 may provide both haptic and/or voice-guided directions to assist the user to locate and grasp an object.

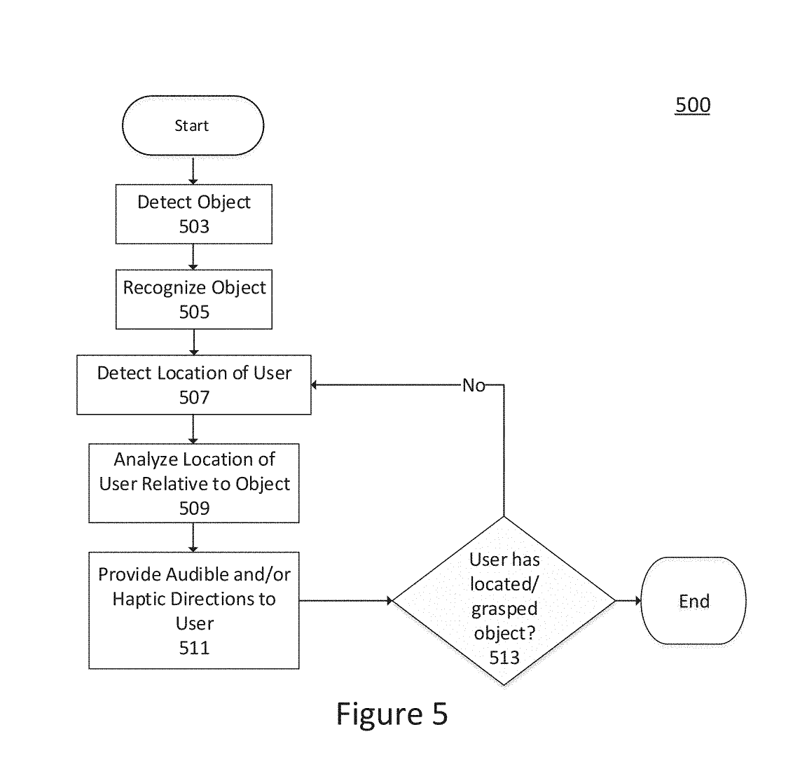

FIG. 5 illustrates an example flow diagram 500 in accordance with a process of assisting a user to locate and grasp an object. In embodiments, at a block 503, a location of the object within an environment may be detected based on a data feed from a 3D depth-camera, e.g., by a computer device. Next, in embodiments, at a block 505, the object may be recognized, e.g., by a computer device. In embodiments, the object may be detected and recognized, based at least in part on the data feed from the 3D depth camera and a prior data feed from the 3D depth camera. At a next block 507, according to various embodiments, a location of user wearing (or co-located with) the 3D depth-camera may be detected, e.g., by the computer device. In some embodiments, detecting the location may include detecting a location of a user's palm or hand. At a next block 509, in the embodiment, the location of the user or user's hand relative to the location of the recognized object may be analyzed, e.g., by the computer device. Finally, for the embodiment, at block 511 audible and/or haptic directions to assist the user to locate and/or grasp the recognized object within the environment may be provided, e.g., by the computer device. At a next decision block 513, in embodiments, a determination may be made, e.g., by the computer device, via the 3D depth camera on whether the user has located or grasped the object. If the answer is yes, the process may finish at end block 515. In embodiments, if the answer is no, the process may return to blocks 507-511 to repeat the steps of detecting the location of the user/user's hand, analyzing the location of the user/user's hand relative to the object, and providing audible and/or haptic directions to the user, until the user has grasped the object and the answer at decision block 513 is yes.

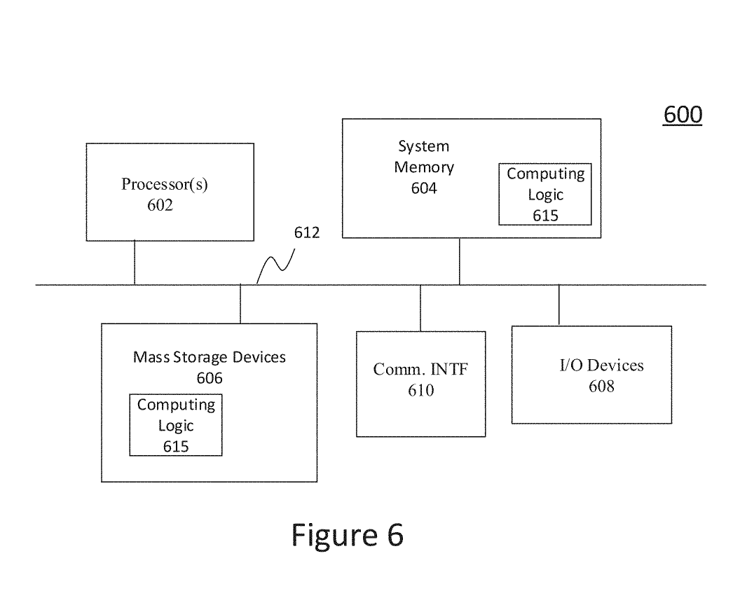

FIG. 6 illustrates an example computer system that may be suitable as another device to practice selected aspects of the present disclosure. As shown, computer 600 may include one or more processors 602, each having one or more processor cores, and system memory 604. Additionally, computer 600 may include mass storage devices 606 (such as diskette, hard drive, compact disc read only memory (CD-ROM) and so forth), input/output devices 608 (such as display, keyboard, cursor control and so forth) and communication interfaces 610 (such as network interface cards modems, infrared receivers, radio receivers (e.g., Bluetooth), and so forth).

The elements may be coupled to each other via system bus 612, which may represent one or more buses. In the case of multiple buses, they may be bridged by one or more bus bridges (not shown). Each of these elements may perform its conventional functions known in the art. In particular, system memory 604 and mass storage devices 606 may be employed to store a working copy and a permanent copy of the programming instructions implementing the operations associated with visual assistance device as described in connection with FIG. 4, collectively denoted as computing logic 612. Computing logic 612 may be implemented by assembler instructions supported by processor(s) 602 or high-level languages, such as, for example, C, that can be compiled into such instructions. The programming instructions may be pre-loaded at manufacturing time, or downloaded onto computer system 600 at the field.

Note that in embodiments, communication interfaces 610 may include one or more communications chips and may enable wired and/or wireless communications for the transfer of data to and from the computing device 600. In some embodiments, a 3D Depth camera and a speech-based interaction device discussed in previous FIGS. 1-5 may be included in or coupled wired or wirelessly to computer 600. In embodiments, communication interfaces 610 may include a transceiver including a transmitter and receiver or a communications chip including the transceiver. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication interfaces 610 may implement any of a number of wireless standards or protocols, including but not limited to IEEE 702.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The communication interfaces 610 may include a plurality of communication chips. For instance, a first communication chip may be dedicated to shorter range wireless communications such as Wi-Fi and Bluetooth, and a second communication chip may be dedicated to longer range wireless communications such as GPS, EDGE, GPRS, CDMA, WiMAX, LTE, Ev-DO, and others.

The elements may be coupled to each other via system bus 612, which may represent one or more buses. In the case of multiple buses, they may be bridged by one or more bus bridges (not shown). Each of these elements may perform its conventional functions known in the art. The number, capability and/or capacity of these elements 602-610 may vary, depending on whether computer 600 is used as a mobile device, a wearable device, a stationary device or a server. When use as mobile device, the capability and/or capacity of these elements 602-610 may vary, depending on whether the mobile device is a smartphone, a computing tablet, an ultrabook or a laptop. Otherwise, the constitutions of elements 602-610 are known, and accordingly will not be further described.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.”

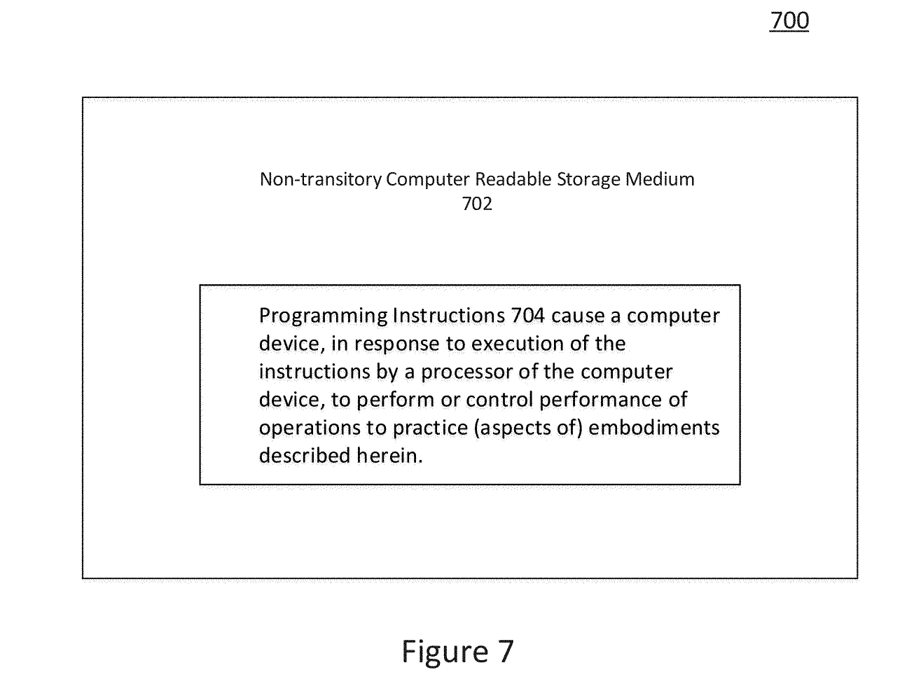

Furthermore, the present disclosure may take the form of a computer program product embodied in any tangible or non-transitory medium of expression having computer-usable program code embodied in the medium. FIG. 7 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 702 may include a number of programming instructions 704. Programming instructions 704 may be configured to enable a device, e.g., device 101 or computer 600, in response to execution of the programming instructions, to perform, e.g., various operations associated with device 101. For example, in an embodiment, device 400 may perform various operations such as acquire an input feed of data from a 3D depth camera co-located with a user to identify a plurality of objects and their locations relative to the user as the user moves within an environment; acquire an additional input feed of data from the 3D depth camera to update identification or recognition of the plurality of objects and their locations relative to the user as the user moves within the environment; and based upon the updated identification of the plurality of objects and their locations, provide directions to audibly communicate to the user a location of a recognized object of the plurality as the user moves toward the recognized object in the environment.

In alternate embodiments, programming instructions 704 may be disposed on multiple computer-readable non-transitory storage media 702 instead. In alternate embodiments, programming instructions 704 may be disposed on computer-readable transitory storage media 702, such as, signals. Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Thus various example embodiments of the present disclosure have been described including, but are not limited to:

Example 1 is an apparatus to assist a visually-impaired user, the apparatus comprising: a 3D depth camera to be co-located with the visually-impaired user to: collect data to recognize an object in the environment; and collect data to locate the object relative to the visually-impaired user in the environment; and a speech-based interaction device to communicate to the visually-impaired user recognition and location of the object based on the data collected by the 3D depth camera.

Example 2 is the apparatus of Example 1, wherein the speech-based interaction device includes speakers to provide voice-guided directions to the visually-impaired user to avoid the location of the object based on the data collected by 3D depth camera.

Example 3 is the apparatus of Example 1, further comprising a haptic feedback device to provide tactile feedback to the visually-impaired user to positively or negatively reinforce a location of the visually-impaired user relative to the object.

Example 4 is the apparatus of Example 3, wherein the haptic feedback device is to provide tactile feedback to direct the visually-impaired user to grasp the object based on a location of a palm of the visually-impaired user relative to the object.

Example 5 is the apparatus of Example 1, wherein the 3D depth camera further comprises a radiofrequency (RF) transmitter to transmit the collected data to a remote device and the speech-based interaction device further comprises an RF receiver coupled to receive voice-guided directions to be provided to the visually-impaired user.

Example 6 is the apparatus of any one of Examples 1-5, wherein the speech-based interaction device includes a microphone to receive a command from the visually-impaired user and speakers to provide an audible response to the command including voice-guided directions to the location of the object.

Example 7 is the apparatus of any of Examples 1-5, further comprising: one or more computer processors communicatively coupled to the 3D depth camera; a recognition module to operate on the one or more computer processors to recognize the object, wherein to recognize the object in the environment, the recognition module is to: receive the data collected by the 3D depth camera and process the data to extract image details from the data to recognize the object; and a tracking module to operate on the one or more computing processors to track a palm of the visually-impaired user, wherein to track the palm, the tracking module is to receive an image of joints of the palm of the visually-impaired user and process the image to track joint coordinates of the palm of the visually-impaired user.

Example 8 is a method to direct a user to an object within an environment, comprising: detecting, by a computer device, a location of the object within the environment, based on a data feed from a depth-camera; recognizing, by the computer device, the object, based at least in part on the data feed from the depth-camera and a prior data feed from the depth-camera; detecting, by the computer device, a location of the user, wherein the user is co-located with the depth-camera; analyzing, by the computer device, the location of the user relative to the location of the recognized object; and providing, by the computer device, audible directions to assist the user to locate the recognized object within the environment.

Example 9 is the method of Example 8, wherein detecting, by the computer device, the location of the user co-located with the depth-camera comprises detecting a location of a hand of the user.

Example 10 is the method of Example 9, further comprising providing, by the computer device, instructions to provide tactile feedback to the user to allow the user to grasp the object.

Example 11 is the method of any one of Examples 8-10, further comprising learning, by the computer device, locations of landmarks and additional objects in the environment, from the data feed from the depth-camera.

Example 12 is the method of any one of Examples 8-10, further comprising prior to detecting, by the computer device, the location of the object, receiving, by the computer device a request from the user to locate the object.

Example 13 is one or more non-transitory computer-readable media (CRM) including instructions stored thereon to cause a computing device, in response to execution of the instructions by a processor of the computing device, to perform or control performance of operations to: acquire an input feed of data from a 3D depth camera co-located with a user to identify a plurality of objects and their locations relative to the user as the user moves within an environment; acquire an additional input feed of data from the 3D depth camera to update identification of the plurality of objects and their locations relative to the user as the user moves within the environment; and based upon the updated identification of the plurality of objects and their locations, provide directions to audibly communicate to the user a location of a recognized object of the plurality as the user moves toward the recognized object in the environment.

Example 14 is the one or more non-transitory CRM of Example 13, wherein to provide directions to audibly communicate to the user the location of the recognized object, the instructions to cause the computing device, in response to execution of the instructions by the processor of the computing device, to perform or control performance of operations to: provide directions to a wearable speech-based interaction device over a wireless connection.

Example 15 is the one or more non-transitory CRM of Example 13, wherein to provide directions to audibly communicate to the user the location of the recognized object include instructions to cause the computing device, in response to execution of the instructions by the processor of the computing device, to perform or control performance of operations to: provide directions to audibly communicate to the user directions to grasp the recognized object.

Example 16 is the one or more non-transitory CRM of Example 13, wherein to provide directions to audibly communicate to the user the location of the recognized object include instructions to cause the computing device, in response to execution of the instructions by the processor of the computing device, to perform or control performance of operations to: scan a palm of the user to detect and track coordinates of joints of the palm of the user to determine the directions to audibly communicate to the user to grasp the recognized object.

Example 17 is the one or more non-transitory CRM of Example 16, further to include instructions to cause the computing device, in response to execution of the instructions by the processor of the computing device, to perform or control performance of operations to: detect and track a location of coordinate markers on the recognized object and map the location of the coordinate markers to the coordinates of j oints of the palm of the user to determine the directions to audibly communicate to the user to grasp the recognized object.

Example 18 is an apparatus for assisting a visually-impaired user in an environment, the apparatus comprising: means for: collecting data to recognize an object in the environment; and collecting data to locate the object relative to the visually-impaired user in the environment; and means for communicating to the visually-impaired user recognition and location of the object based on the data collected by the means for collecting the data to recognize and locate the object.

Example 19 is the apparatus of Example 18, wherein means for communicating to the visually-impaired user recognition and location of the object include means for audibly communicating information to the visually-impaired user.

Example 20 is the apparatus of any one of Examples 18-19, wherein the means for collecting data include means for measuring a depth between the visually-impaired user and the object.

Example 21 is an object recognition system to assist a user, comprising: one or more computer processors; an image capture device operated by the one or more of the computer processors to receive an input feed of an environment from a 3D depth camera; an object recognition module to operate on the one or more of the computer processors to recognize an object, wherein to recognize the object, the object recognition module is to: detect the object and recognize the object in the environment based on the input feed and a prior input feed of the environment from the image capture device; and a speech recognition and voice command module to operate on the one or more of the computer processors to provide voice-based assistance, wherein to provide voice-based assistance for the user, the speech recognition and voice command module is to: recognize an audible command from the user and generate voice-based directions for the user to indicate recognition of the object in the environment and detected location of the recognized object in the environment.

Example 22 is the object recognition system of Example 21, further comprising a palm tracking module to operate on the one or more of the computer processors to perform tracking, wherein to perform palm tracking on a palm of the user, the palm tracking module is to determine joint coordinates of a hand of the user from the input feed and track the joint coordinates of the hand of the user.

Example 23 is the object recognition system of Example 22, further comprising a feature points mapping module to operate on the one or more of the computer processors to determine directions, wherein to determine directions to be provided to the user, the feature points mapping module is to receive image data from the image capture device and map feature points of the recognized object to joint coordinates of the hand of the user.

Example 24 is the object recognition system of Example 21, wherein the environment is a household.

Example 25 is the object recognition system of Example 21, further comprising a haptic feedback device coupled wirelessly to the object recognition system to supplement the voice-based assistance for the user.

Example 26 is the object recognition system of Example 21, further comprising a wireless transceiver to transmit information regarding a vibration, force, or motion to be provided to the user via the haptic feedback device.

Example 27 is the object recognition system of any one of Examples 21-26, further comprising a wireless transceiver coupled to the image capture device to receive the input feed of the environment from the 3D depth camera

Although certain embodiments have been illustrated and described herein for purposes of description this application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second, or third) for identified elements are used to distinguish between the elements, and do not indicate or imply a required or limited number of such elements, nor do they indicate a particular position or order of such elements unless otherwise specifically stated.

What is claimed is:

1. An apparatus to assist a visually-impaired user, the apparatus comprising:
a 3D depth camera to be co-located with the visually-impaired user to:
collect data to recognize an object in the environment; and
collect data to locate the object relative to the visually-impaired user in the environment; and
a speech-based interaction device to communicate to the visually-impaired user recognition and location of the object based on the data collected by the 3D depth camera.

2. The apparatus of claim 1, wherein the speech-based interaction device includes speakers to provide voice-guided directions to the visually-impaired user to avoid the location of the object based on the data collected by 3D depth camera.

3. The apparatus of claim 1, further comprising a haptic feedback device to provide tactile feedback to the visually-impaired user to positively or negatively reinforce a location of the visually-impaired user relative to the object.

4. The apparatus of claim 3, wherein the haptic feedback device is to provide tactile feedback to direct the visually-impaired user to grasp the object based on a location of a palm of the visually-impaired user relative to the object.

5. The apparatus of claim 1, wherein the 3D depth camera further comprises a radiofrequency (RF) transmitter to transmit the collected data to a remote device and the speech-based interaction device further comprises an RF receiver coupled to receive voice-guided directions to be provided to the visually-impaired user.

6. The apparatus of claim 1, wherein the speech-based interaction device includes a microphone to receive a command from the visually-impaired user and speakers to provide an audible response to the command including voice-guided directions to the location of the object.

7. The apparatus of claim 1, further comprising:
one or more computer processors communicatively coupled to the 3D depth camera;
a recognition module to operate on the one or more computer processors to recognize the object, wherein to recognize the object in the environment, the recognition module is to:
receive the data collected by the 3D depth camera and process the data to extract image details from the data to recognize the object; and
a tracking module to operate on the one or more computing processors to track a palm of the visually-impaired user, wherein to track the palm, the tracking module is to receive an image of joints of the palm of the visually-impaired user and process the image to track joint coordinates of the palm of the visually-impaired user.

8. A method to direct a user to an object within an environment, comprising:
detecting, by a computer device, a location of the object within the environment, based on a data feed from a depth-camera;
recognizing, by the computer device, the object, based at least in part on the data feed from the depth-camera and a prior data feed from the depth-camera;
detecting, by the computer device, a location of the user, wherein the user is co-located with the depth-camera;
analyzing, by the computer device, the location of the user relative to the location of the recognized object; and
providing, by the computer device, audible directions to assist the user to locate the recognized object within the environment.

9. The method of claim 8, wherein detecting, by the computer device, the location of the user co-located with the depth-camera comprises detecting a location of a hand of the user.

10. The method of claim 9, further comprising providing, by the computer device, instructions to provide tactile feedback to the user to allow the user to grasp the object.

11. One or more non-transitory computer-readable media (CRM) including instructions stored thereon to cause a computing device, in response to execution of the instructions by a processor of the computing device, to perform or control performance of operations to:
acquire an input feed of data from a 3D depth camera co-located with a user to identify a plurality of objects and their locations relative to the user as the user moves within an environment;
acquire an additional input feed of data from the 3D depth camera to update identification of the plurality of objects and their locations relative to the user as the user moves within the environment; and
based upon the updated identification of the plurality of objects and their locations, provide directions to audibly communicate to the user a location of a recognized object of the plurality as the user moves toward the recognized object in the environment.

12. The one or more non-transitory CRM of claim 11, wherein to provide directions to audibly communicate to the user the location of the recognized object, the instructions to cause the computing device, in response to execution of the instructions by the processor of the computing device, to perform or control performance of operations to:
provide directions to a wearable speech-based interaction device over a wireless connection.

13. The one or more non-transitory CRM of claim 11, wherein to provide directions to audibly communicate to the user the location of the recognized object include instructions to cause the computing device, in response to execution of the instructions by the processor of the computing device, to perform or control performance of operations to:
provide directions to audibly communicate to the user directions to grasp the recognized object.

14. The one or more non-transitory CRM of claim 13, wherein to provide directions to audibly communicate to the user the location of the recognized object include instructions to cause the computing device, in response to execution of the instructions by the processor of the computing device, to perform or control performance of operations to:
scan a palm of the user to detect and track coordinates of joints of the palm of the user to determine the directions to audibly communicate to the user to grasp the recognized object.

15. The one or more non-transitory CRM of claim 14, further to include instructions to cause the computing device, in response to execution of the instructions by the processor of the computing device, to perform or control performance of operations to:
detect and track a location of coordinate markers on the recognized object and map the location of the coordinate markers to the coordinates of j oints of the palm of the user to determine the directions to audibly communicate to the user to grasp the recognized object.

16. An apparatus for assisting a visually-impaired user in an environment, the apparatus comprising:
means for:
collecting data to recognize an object in the environment; and
collecting data to locate the object relative to the visually-impaired user in the environment; and
means for communicating to the visually-impaired user recognition and location of the object based on the data collected by the means for collecting the data to recognize and locate the object.

17. The apparatus of claim 16, wherein means for communicating to the visually-impaired user recognition and location of the object include means for audibly communicating information to the visually-impaired user.

18. The apparatus of claim 16, wherein the means for collecting data include means for measuring a depth between the visually-impaired user and the object.

19. An object recognition system to assist a user, comprising:
one or more computer processors;
an image capture device operated by the one or more of the computer processors to receive an input feed of an environment from a 3D depth camera;
an object recognition module to operate on the one or more of the computer processors to recognize an object, wherein to recognize the object, the object recognition module is to:
detect the object and recognize the object in the environment based on the input feed and a prior input feed of the environment from the image capture device; and
a speech recognition and voice command module to operate on the one or more of the computer processors to provide voice-based assistance, wherein to provide voice-based assistance for the user, the speech recognition and voice command module is to:
recognize an audible command from the user and generate voice-based directions for the user to indicate recognition of the object in the environment and detected location of the recognized object in the environment.

20. The object recognition system of claim 19, further comprising a palm tracking module to operate on the one or more of the computer processors to perform tracking, wherein to perform palm tracking on a palm of the user, the palm tracking module is to determine joint coordinates of a hand of the user from the input feed and track the joint coordinates of the hand of the user.

21. The object recognition system of claim 20, further comprising a feature points mapping module to operate on the one or more of the computer processors to determine directions, wherein to determine directions to be provided to the user, the feature points mapping module is to receive image data from the image capture device and map feature points of the recognized object to joint coordinates of the hand of the user.

22. The object recognition system of claim 19, wherein the environment is a household.

23. The object recognition system of claim 19, further comprising a haptic feedback device coupled wirelessly to the object recognition system to supplement the voice-based assistance for the user.

24. The object recognition system of claim 23, further comprising a wireless transceiver to transmit information regarding a vibration, force, or motion to be provided to the user via the haptic feedback device.

25. The object recognition system of claim 19, further comprising a wireless transceiver coupled to the image capture device receive the input feed of the environment from the 3D depth camera
